(19) United States
(12) Patent Application Publication
(10) Pub. No.: US 2020/0359097 A1
(43) Pub. Date: Nov. 12, 2020

(54) ELECTRONIC DEVICE AND CONTROL METHOD THEREFOR

(71) Applicant: SAMSUNG ELECTRONICS CO., LTD., Suwon-si (KR)

(72) Inventors: Youngjoon YOO, Suwon-si (KR); Sungwon KIM, Suwon-si (KR); Injune BAEK, Suwon-si (KR); Bongseok LEE, Suwon-si (KR); Heeran LEE, Suwon-si (KR)

(73) Assignee: SAMSUNG ELECTRONICS CO., LTD., Suwon-si (KR)

(21) Appl. No.: 16/766,008

(22) PCT Filed: Dec. 7, 2018
(86) PCT No.: PCT/KR2018/015512

§ 371 Date: May 21, 2020

(30) Foreign Application Priority Data
Dec. 12, 2017 (KR) 10-2017-0170677

(51) Int. Cl. H04N 21/466; H04N 21/442; H04N 21/45; H04N 21/258

(52) U.S. Cl. CPC H04N 21/4668; H04N 21/25891; H04N 21/4532; H04N 21/44222

(57) ABSTRACT

An electronic device is disclosed. The electronic device comprises: a memory for storing information related to a viewing history of content; and a processor for determining a keyword for a content search on the basis of information related to the viewing history, acquiring a content search result for a keyword for each of a plurality of content sources, and providing, on the basis of the acquired content search result, a content recommendation UI including recommended content provided by each of the plurality of content sources.

### BACKGROUND ART

### Technical Field

The disclosure relates to an electronic device and a control method therefor, and more particularly, to an electronic device that is capable of recommending contents of a plurality of content sources on the basis of a viewing history, and a control method therefor.

### Description of the Related Art

As electronic technologies are developing, technologies of providing numerous contents by using various display devices are also developing continuously. Among them, display devices providing various contents based on communication with users such as an IPTV and a DTV are gaining popularity recently.

Meanwhile, as numerous contents are provided one-sidedly to users through such devices, users' inconvenience regarding time and effort spent until a desired content is selected occurred. For resolving such inconvenience, recently, a service of recommending contents to users appeared.

However, in a conventional method of identifying a user's interest based on the total content viewing time and recommending contents, there was a problem that, in the case of a device such as a TV that several users use together, the device cannot reflect a specific user's interest.

Also, a TV provides not only linear contents such as broadcasting programs but also non-linear contents such as streaming video contents through applications, but a TV itself cannot have a viewing history of a non-linear content, and thus it was only possible to recommend contents through applications. In this case, contents that the entire users of an application viewed a lot were recommended in general. However, such a recommendation method had a problem that the interest of any one user could not be reflected. Also, there was a method of recommending contents based on an application use history of a user who logged in, but such a recommendation method had a problem that it could not be utilized without a login.

### DETAILED DESCRIPTION OF THE INVENTION

### Technical Problem

The disclosure is for addressing the aforementioned problems, and the purpose of the disclosure is in providing an electronic device that is capable of recommending contents of a plurality of content sources on the basis of a viewing history, and a control method therefor.

### Technical Solution

An electronic device according to an embodiment of the disclosure for achieving the aforementioned purpose includes a memory configured to store information related to a viewing history of a content, and a processor configured to determine a keyword for a content search on the basis of information related to the viewing history, acquire a content search result for the keyword for each of a plurality of content sources, and provide, on the basis of the acquired content search result, a content recommendation UI including the recommended contents provided by each of the plurality of content sources.

In this case, the electronic device according to this embodiment may further include a tuner configured to receive a broadcasting signal, and a communicator configured to connect with an external content providing device. The processor may acquire at least one of first information related to a viewing history of a content corresponding to a broadcasting signal received through the tuner, second information related to a viewing history of a content provided from the external content providing device through the communicator, or third information related to a viewing history of a video on demand (VOD) content provided through an application stored in the memory, and store the information in the memory.

In this case, the processor may determine a keyword for a content search based on at least one of the first information, the second information, or the third information.

Meanwhile, the processor may determine a keyword for a content search for each time zone on the basis of the information related to the viewing history.

Meanwhile, the keyword may be associated with at least one of the title, the genre, the producer, or the cast of a viewed content.

Meanwhile, the content recommendation UI may provide recommended contents of each of the plurality of content sources simultaneously.

Meanwhile, the memory may store use history information for each of the plurality of content sources, and the processor may determine the arrangement order of recommended contents provided in the content recommendation UI on the basis of the use history information.

Meanwhile, the memory may store use history information for each of the plurality of content sources, and the processor may determine the number of recommended contents of each of the plurality of content sources to be provided in the content recommendation UI on the basis of the use history information.

Meanwhile, the processor may analyze an image of a viewed content and acquire the information related to the viewing history.

Meanwhile, the plurality of content sources may include a real time broadcasting program providing source and a VOD content providing source.

Meanwhile, the processor may output an image signal corresponding to the content recommendation UI to an external display device and provide the content recommendation UI through the external display device.

Meanwhile, a method for controlling an electronic device according to an embodiment of the disclosure includes the steps of determining a keyword for a content search on the basis of information related to a viewing history of a content, acquiring a content search result for the keyword for each of a plurality of content sources, and providing, on the basis of the acquired content search result, a content recommendation UI including the recommended contents provided by each of the plurality of content sources.

In this case, the control method according to this embodiment may further include the step of acquiring at least one of first information related to a viewing history of a content corresponding to a broadcasting signal received through the tuner of the electronic device, second information related to a viewing history of a content provided from an external content providing device connected with the electronic device, or third information related to a viewing history of a video on demand (VOD) content provided through an application stored in the electronic device.

In this case, in the step of determining a keyword, a keyword for a content search may be determined based on at least one of the first information, the second information, or the third information.

Meanwhile, in the step of determining a keyword, a keyword for a content search for each time zone may be determined on the basis of the information related to the viewing history.

Meanwhile, the content recommendation UI may provide recommended contents of each of the plurality of content sources simultaneously.

Meanwhile, the arrangement order of recommended contents provided in the content recommendation UI may be determined on the basis of the use history information for each of the plurality of content sources.

Meanwhile, the number of recommended contents of each of the plurality of content sources to be provided in the content recommendation UI may be determined on the basis of the use history information for each of the plurality of content sources.

Meanwhile, the control method according to this embodiment may further include the step of analyzing an image of a viewed content and acquiring the information related to the viewing history.

Meanwhile, in a non-transitory computer-readable medium according to an embodiment of the disclosure, the non-transitory computer-readable medium stores a computer instruction making the device perform an operation including the steps of determining a keyword for a content search on the basis of information related to a viewing history of a content, acquiring a content search result for the keyword for each of a plurality of content sources, and providing, on the basis of the acquired content search result, a content recommendation UI including the recommended contents provided by each of the plurality of content sources, when the instruction is executed by the processor of the device.

### BRIEF DESCRIPTION OF DRAWINGS

FIG. 1 is a block diagram for illustrating a configuration of an electronic device according to an embodiment of the disclosure;

FIG. 2 is a block diagram for illustrating a configuration of an electronic device according to another embodiment of the disclosure;

FIG. 3 is a diagram for illustrating an example of a method of determining a keyword for a content search for each time zone on the basis of a viewing history;

FIG. 4 is a diagram for illustrating an example of a method of determining a keyword for a content search for each time zone on the basis of a viewing history;

FIG. 5 is a diagram for illustrating an example of a method of determining a keyword for a content search for each time zone on the basis of a viewing history;

FIG. 6 is a diagram for illustrating a content recommendation UI according to the various embodiments of the disclosure;

FIG. 7 is a diagram for illustrating a content recommendation UI according to the various embodiments of the disclosure;

FIG. 8 is a diagram for illustrating an example of content recommendation on the basis of the use history of content sources;

FIG. 9 is a diagram for illustrating an example of content recommendation on the basis of the use history of content sources;

FIG. 10 is a flow chart for illustrating a control method of an electronic device according to an embodiment of the disclosure; and

FIG. 11 is a diagram for illustrating a method of providing an image of an electronic device according to an embodiment of the disclosure.

### MODE FOR IMPLEMENTING THE INVENTION

Before describing the disclosure in detail, the description format of this specification and the drawings will be described.

As terms used in this specification and the claims, general terms were selected in consideration of the functions described in the various embodiments of the disclosure. However, the terms may vary depending on the intention of those skilled in the art who work in the pertinent field, legal or technical interpretation, emergence of new technologies, and the like. Also, there are some terms that were designated by the applicant on his own, and in such cases, the meaning of the terms will be interpreted as defined in this specification. In case there is no specific definition of the terms, the meaning of the terms will be interpreted based on the overall content of this specification and common technical knowledge in the pertinent technical field.

Also, the same reference numerals or symbols described in each drawing accompanying this specification refer to components or elements performing substantially the same functions. For the convenience of explanation and understanding, the components or elements will be explained by using the same reference numerals or symbols in different embodiments. That is, even if elements having the same reference numerals are all described in a plurality of drawings, the plurality of drawings do not mean one embodiment.

In addition, in this specification and the claims, terms including ordinal numbers such as “the first,” “the second,” etc. may be used for distinguishing elements. These ordinal numbers are used only to distinguish the same or similar elements from one another, and the meaning of the terms are not to be interpreted in a restrictive way due to use of such ordinal numbers. For example, the orders of use or the orders of arrangement, etc. of elements combined with such ordinal numbers are not to be restricted by the numbers. Also, depending on needs, each ordinal number may be interchangeably used.

Also, in this specification, singular expressions include plural expressions, unless defined obviously differently in the context. Further, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in the embodiments of the disclosure, terms such as “a module,” “a unit,” and “a part” are for referring to elements performing at least one function or operation, and these elements may be implemented as hardware or software, or as a combination of hardware and software. Further, a plurality of “modules,” “units,” and “parts” may be integrated into at least one module or chip and implemented as at least one processor, except when each of them needs to be implemented as independent specific hardware.

Also, in the embodiments of the disclosure, the description that a portion is connected to another portion includes both the case where a portion is directly connected to another portion, and the case where a portion is indirectly connected to another portion through still another medium. In addition, the description that a portion includes an element means that other elements may additionally be included, but not that other elements are excluded, unless there is any specific description meaning the contrary.

Hereinafter, the disclosure will be described in detail with reference to the accompanying drawings.

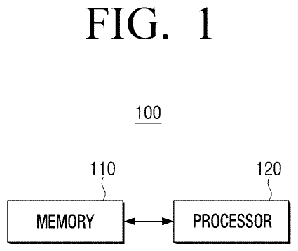

FIG. 1 is a block diagram for illustrating a configuration of an electronic device according to an embodiment of the disclosure.

Referring to FIG. 1, the electronic device 100 includes a memory 110 and a processor 120. The components illustrated in FIG. 1 are exemplary ones for implementing the embodiments of the disclosure, and appropriate hardware/software components of a level obvious to those skilled in the art may additionally be included in the electronic device 100.

The electronic device 100 may be implemented as electronic devices in various forms such as a TV, a set-top box, an electronic blackboard, an electronic table, a large format display (LFD), a smartphone, a tablet, a desktop PC, a laptop computer, a server, etc.

The memory 110 may store instructions or data related to at least one other component of the electronic device 100. The memory 110 may be implemented as, for example, a non-volatile memory, a volatile memory, a flash-memory, a hard disk drive (HDD), or a solid state drive (SDD), etc. Also, the memory 110 may be accessed by the processor 120, and reading/recording/correction/deletion/update, etc. of data by the processor 120 may be performed.

In the disclosure, the term memory may refer to a memory that is separately provided from the processor 120, or a ROM (not shown) or a RAM (not shown) inside the processor 120, and the memory may be implemented not only as a storage medium inside the electronic device 100 but also as an external storage medium, for example, a micro SD card, a USB memory, or a web server through a network, etc.

The memory 110 may store information related to a viewing history of a content. Here, a content means media including at least one of texts, audio, a still image, a moving image, etc.

In the memory 110, information related to viewing histories of contents of various content sources may be stored. In particular, in the memory 110, information related to a viewing history of a content of a linear content source (or a real time broadcasting program providing source) and information related to a viewing history of a content of a non-linear content source (or a VOD content providing source) may be stored. A linear content means a content that a viewer watches according to the programming set by a broadcasting business operator, and a non-linear content means a content that a viewer can select and watch without limitation on the time. Meanwhile, a content source may mean a content provider.

For example, information related to a viewing history of a content corresponding to a broadcasting signal received at the electronic device 100 may be stored in the memory 110, and in case the electronic device 100 is connected to an external content providing device, information related to a viewing history of a content provided from the external content providing device and viewed may be stored in the memory 110. Here, the external content providing device may be, for example, a storage media player like a game machine, Blue ray, a DVD, etc., an over the top (OTT) device, and a set-top box providing services such as cable broadcasting, Internet protocol television (IPTV), satellite broadcasting, etc. Also, in case an application for providing video on demand (VOD) contents is stored in the memory 110, information related to a viewing history of a VOD content provided through such an application may be stored in the memory 110. Here, an application may be, for example, an application for video streaming services such as NETFLIX™, YouTube™, iTunes™, Hulu™, and VUDU™, and in addition to them, it may be an Internet web browser application. Also, information related to a viewing history of a content stored in a storage medium included in the electronic device 100 or an external storage medium (e.g., a USB, a web server) may be stored in the memory 110.

Information related to a viewing history may include various kinds of information related to a viewed content. For example, information related to a viewing history may include information regarding the name of the content source that provided the content, the name of the content, the genre of the content, the producer of the content, the cast of the content, the date, day, and time of viewing the content (e.g., the starting time of viewing the content and the finishing time of viewing the content), etc.

Also, in the memory 110, use history information for each of a plurality of content sources may be stored.

The processor 120 may control the overall operations and functions of the electronic device 100. The processor 120 may be implemented as, for example, a Central Processing Unit (CPU), an Application specific Integrated Circuit (ASIC), an System on Chip (SoC), a Microcomputer (MICOM), etc.

The processor 120 may acquire information related to various viewing histories as described above and store the information in the memory 110. For example, the processor 120 may acquire at least one of information related to a viewing history of a content corresponding to a broadcasting signal, information related to a viewing history of a content provided from an external content providing device, or information related to a viewing history of a video on demand (VOD) content provided through an application stored in the memory 110, and store the information in the memory 110.

According to an embodiment of the disclosure, the processor 120 may acquire information related to a viewing history through an image analysis method. For example, the processor 120 may analyze an image of a content that is currently being viewed and identify what the currently viewed content is, and acquire information related to a viewing history based on the identification result. According to another embodiment of the disclosure, it is also possible that the processor 120 is provided with information related to a viewing history of a content from an external manufacturer.

The processor 120 may determine a keyword for a content search on the basis of information related to the acquired viewing history. Here, the keyword may be associated with at least one of information expressing a content such as the title, the genre, the producer, the cast, etc. of the content.

For example, the processor 120 may analyze information related to a content viewing history and determine the name, the genre, etc. of a content having a high viewing rate as a keyword.

According to an embodiment of the disclosure, the processor 120 may determine keywords for each time zone from information related to a viewing history. For example, the processor 120 may analyze information related to a viewing history and determine cooking which is a genre having a high viewing rate from 10:00 a.m. to 11:00 a.m. as a keyword corresponding to from 10:00 a.m. to 11:00 a.m., and determine sport which is a genre having a high viewing rate from 9:00 p.m. to 10:00 p.m. as a keyword corresponding to from 9:00 p.m. to 10:00 p.m.

The processor 120 may acquire a content search result for a keyword for each of a plurality of content sources. That is, the processor 120 may search a content by using a keyword for each subject providing a content. For example, the processor 120 may search a content provided by an IPTV service to which the electronic device 100 subscribes, search a content provided by NETFLIX™, search a content provided by YouTube™, and search a content stored in a USB connected with the electronic device 100, by using a keyword determined on the basis of information related to a viewing history.

Also, the processor 120 may provide a content recommendation UI including recommended contents provided by each of the plurality of content sources, on the basis of the content search results of each of the plurality of content sources. A content recommendation UI may include information on recommended contents. For example, a content recommendation UI may include information on the summaries of recommended contents, thumbnail images expressing recommended contents, channels broadcasting recommended contents, etc. As another example, a content recommendation UI may include hyperlink texts, hyperlink images, etc. that make recommended contents output when they are selected by users. A content recommendation UI may provide recommended contents of each of a plurality of content sources simultaneously. Accordingly, linear contents and non-linear contents may be recommended simultaneously on one screen.

According to an embodiment of the disclosure, a content recommendation UI may be provided through a display included in the electronic device 100. In this case, the processor 120 may control the display included in the electronic device 100 such that a content recommendation UI is displayed. According to another embodiment of the disclosure, a content recommendation UI may be provided at an external display device which is a separate device from the electronic device 100. For example, the electronic device 100 may be implemented as a server, a set-top box, etc. that communicates with external display devices such as a TV, a smartphone, a monitor, etc. In this case, the processor 120 may provide a content recommendation UI by outputting an image signal corresponding to the content recommendation UI to the external display device.

Meanwhile, in the aforementioned embodiment, it was described that contents of a plurality of content sources are searched and recommended, but the number of content sources is not necessarily limited to a plural number, and it is possible that contents of one content source are searched and recommended.

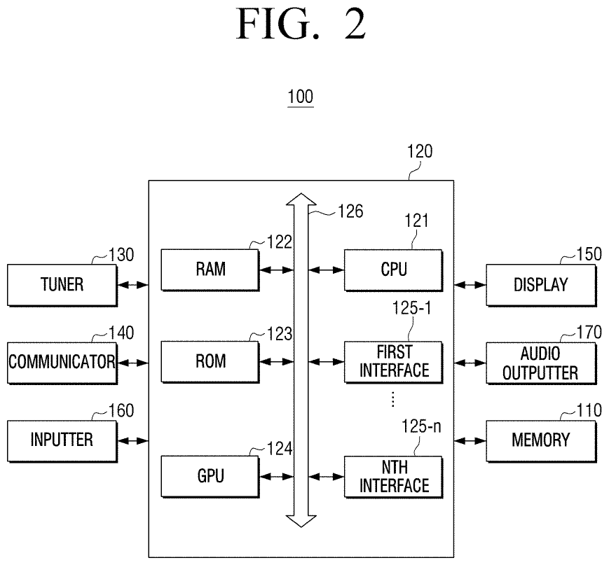

FIG. 2 is a block diagram illustrating the configuration of the electronic device 100 according to another embodiment of the disclosure.

Referring to FIG. 2, the electronic device 100 may include a memory 110, a processor 120, a tuner 130, a communicator 140, a display 150, an inputter 160, and an audio outputter 170. Depending on embodiments, some of the components may be omitted, and appropriate hardware/software components of a level obvious to those skilled in the art may be additionally included in the electronic device 100, although they are not shown.

The tuner 130 may select a broadcasting signal received via wire or wirelessly by tuning only the frequency of the channel that is to be received at the electronic device 100 among many electronic wave components through amplification, mixing, resonance, etc. A broadcasting signal may include videos, audio, and additional data (e.g., an electronic program guide (EPG)).

Also, the tuner 130 may receive a broadcasting signal including videos, audio, and additional data in a frequency band corresponding to a channel number corresponding to a user input.

In addition, the tuner 130 may receive broadcasting signals from various sources such as ground wave broadcasting, cable broadcasting, and satellite broadcasting. Also, the tuner 130 may receive broadcasting signals from various sources and sources such as analog broadcasting and digital broadcasting.

Further, the tuner 130 may be implemented as an all-in-one type with the electronic device 100, or as a separate device (e.g., a tuner connected with the communicator 140) that is electronically connected with the electronic device 100.

The communicator 140 is a component for performing communication with an external device according to various types of communication methods. The communicator 140 may be connected with an external server through a network such as the Internet, and transmit and receive various kinds of information. Meanwhile, the communicator 140 may perform communication with an external device by communication methods such as infrared Data Association (IrDA), Radio Frequency Identification (RFID), Near Field Communication (NFC), Wireless Fidelity (Wi-Fi), ultra wideband (UWB), WirelessDisplay (WiDi), WirelessHD (WiHD), Wireless Home Digital Interface (WHDI), Miracast, Wireless Gigabit Alliance (Wigig), Wi-Fi Direct, Bluetooth (ex. Bluetooth Classic), Bluetooth Low Energy, AirPlay, Z-wave, 4LoWPAN, LTE D2D, GPRS, Weightless, Edge Zigbee, Digital Living Network Alliance (DLNA), ANT+, Digital Enhanced Cordless Telecommunications (DECT), wireless local area network (WLAN), Global System for Mobile communications (GSM), Universal Mobile Telecommunication System (UMTS), Long-Term Evolution (LTE), Wireless Broadband (WiBRO), etc.

Also, the communicator 140 may include an input port that can be connected with an external device via wire. For example, the communicator 140 may include at least one of ports such as a component input jack, a High-Definition Multimedia Interface (HDMI) input port, a Universal Serial Bus port (USB port), an Red Green Blue terminal (RGB terminal), a Digital Visual Interface (DVI), an High-Definition Multimedia Interface (HDMI), a Display Port (DP), a thunderbolt, etc. The electronic device 100 may be connected with an external content providing device through such an input port. For example, the electronic device 100 may be connected with a set-top box through an HDMI input port.

In addition, the communicator 140 may be implemented as a transceiver for performing at least one of the aforementioned communication methods.

The electronic device 100 may receive various kinds of information from an external server through the communicator 140. For example, the electronic device 100 may receive information related to a viewing history of a content from an external server through the communicator 140, and the processor 120 may determine a keyword for a content search on the basis of the received information related to a viewing history.

The display 150 is a component for displaying images, and may output, for example, an image included in a broadcasting signal received through the tuner 130, or an image input through the communicator 140, or an image included in an image file stored in the memory 110. Also, the display 150 may display a content recommendation UI.

Also, the display 150 may be implemented as, for example, a liquid crystal display (LCD), and depending on cases, the display 150 may be implemented as a cathode-ray tube (CRT), a plasma display panel (PDP), organic light emitting diodes (OLED), transparent OLED (TOLED), etc. In addition, the display 150 may be implemented in the form of a touch screen that can detect touch manipulations of a user.

The audio outputter 170 is a component for outputting audio, and may output, for example, audio included in a broadcasting signal received through the tuner 130, or audio input through the communicator 140, or audio included in an audio file stored in the memory 110. Also, the audio outputter 170 may include a speaker and/or a headphone output terminal.

The inputter 160 is a component for receiving input of user instructions for manipulating the electronic device 100. The inputter 160 may receive, for example, an instruction to select a recommended content from a user, and also, receive a user instruction for change of a channel.

Also, the inputter 160 may be implemented to include, for example, a button provided on the electronic device 100, a touch panel (in case the display 150 is implemented as a touch screen), or an IR signal receiver of a remote control (in case the electronic device 100 is controlled through an external remote control), etc.

The memory 110 stores various kinds of data and an operating system (OS) for operating and controlling the electronic device 100. The memory 110 may be the same as the memory 110 described in FIG. 1.

Also, the memory 110 may store a third party application operating on the electronic device's own platform. For example, an application providing VOD contents such as NETFLIX™ and YouTube™ may be stored in the memory 110.

In addition, the memory 110 may store information related to a viewing history of a content, and may store information on a use history of each of a plurality of content sources. Information related to a viewing history of a content may be used for determining a keyword for a content search, and information on a use history of a content source may be used for determining which content source is to be used to provide recommended contents.

The processor 120 may control the overall operations of the electronic device 100. For example, the processor 120 may control the overall operations of the electronic device 100 by using various kinds of modules stored in the memory 110. Also, the processor 120 may perform the functions of the processor 120 described in FIG. 1.

The processor 120 includes a RAM 122, a ROM 123, a GPU 124, a CPU 121, first to nth interfaces 125-1 to 125-n, and a bus 126, as illustrated in FIG. 2. Here, the RAM 122, the ROM 123, the GPU 124, the CPU 121, and the first to nth interfaces 125-1 to 125-n may be connected with one another through the bus 126.

The ROM 123 stores a set of instructions, etc. for system booting. When a turn-on instruction for the electronic device 100 is input and power is supplied, the CPU 121 copies the O/S stored in the memory 110 in the RAM 122 according to the instruction stored in the ROM 123, and boots the system by executing the O/S. When booting is completed, the CPU 121 may copy the various kinds of programs stored in the memory 110 in the RAM 122, and perform various kinds of operations by executing the programs copied in the RAM 122. The CPU 121 may perform various kinds of operations by using the various kinds of program modules, data, etc. stored in the memory 110.

When booting of the electronic device 100 is completed, the GPU 124 may display an image. The GPU 124 may generate a screen including various objects such as icons, images, texts, etc. by using an operation part and a rendering part. The operation part operates attribute values such as coordinate values, shapes, sizes, and colors by which each object will be displayed according to the layout of the screen. The rendering part generates screens in various layouts including objects, based on the attribute values operated at the operation part. The screens generated at the rendering part are provided to the display 150, and are displayed in a display area.

The first to nth interfaces 125-1 to 125-n may be connected with the aforementioned various kinds of components 110, 130 to 170. One of the interfaces may be a network interface connected with an external device through a network.

The processor 120 may acquire information related to viewing histories of various content sources and store the information in the memory 110. For example, the processor 120 may acquire not only information related to a viewing history of a linear content but also information related to a viewing history of a non-linear content. A linear content means a content that a viewer watches according to the programming set by a broadcasting business operator, and for example, a broadcasting content corresponding to a broadcasting signal received through the tuner 130, or a broadcasting content viewed through an external content providing device (e.g., a set-top box) providing ground wave broadcasting, cable broadcasting, satellite broadcasting, etc. falls under a linear content. Meanwhile, a non-linear content means a content that a viewer can select and watch without limitation on the time such as a VOD content, a content stored in a storage medium, etc.

The processor 120 may store information related to a viewing history of a content corresponding to a broadcasting signal received through the tuner 130 in the memory 110. Also, the processor 120 may store information related to a viewing history of a content provided from an external content providing device connected through the communicator 140 and viewed in the memory 110. Here, the external content providing device may be, for example, a storage media player like a game machine, Blue ray, a DVD, etc., an over the top (OTT) device, and a set-top box providing cable broadcasting, Internet protocol television (IPTV), satellite broadcasting, etc.

According to an embodiment of the disclosure, the processor 120 may acquire information related to a viewing history through an image analysis method or technologies such as automatic content recognition (ACR), etc. For example, the processor 120 may acquire feature information by which a content can be identified from a content image and identify what the viewed content is based on the information, and generate viewing history information.

Also, according to an embodiment of the disclosure, the processor 120 may acquire texts included in a content image that is being output as feature information. The processor 120 may acquire, for example, texts such as a channel number, a channel name, a program name, a channel call sign, a content title, etc. included in a content image. For acquiring texts, an optical character recognition (OCR) technology may be used. For example, the processor 120 may recognize a channel name included in a content corresponding to a broadcasting signal by OCR, and recognize a content title of a moving image provided through the YouTube™ application by OCR.

According to another embodiment of the disclosure, the processor 120 may acquire an image included in a content image that is being output as feature information. The processor 120 may acquire, for example, the logo of a broadcasting company in a content image as feature information.

According to still another embodiment of the disclosure, the processor 120 may acquire a video/audio fingerprint in a content image that is being output as feature information. A fingerprint means intrinsic data for images or sound of some sections of a content, and reflects the intrinsic features of a signal itself, unlike metadata based on texts. Accordingly, a fingerprint is also referred to as fingerprint data, DNA data, or genetic data. For example, an audio fingerprint acquired from an audio signal is information expressing features such as the frequency, the amplitude, etc. of the audio signal, and a video fingerprint acquired from an image signal is information expressing features such as the motion vector, the color, etc. of the image signal.

For example, the processor 120 may acquire feature points including a specific coordinate in an image frame and the sizes of direction values of the coordinate by a specific standard, select some feature points in the order of having bigger direction values, and set a specific relation among the selected feature points, and thereby acquire video feature information for the one image frame. Also, the processor 120 may divide an audio signal by specific time intervals, calculate the sizes of the signals of frequencies included in each time interval, calculate the frequency tilt by obtaining the size differences among the signals of adjacent frequency sections, and quantize the tilt as 1 in case the tilt is a positive number, and quantize the tile as 0 in case the tilt is a negative number, and thereby acquire an audio fingerprint.

In addition, the processor 120 may identify a content on the basis of feature information acquired as described above. For example, the acquired feature information may be transmitted to an external matching server including a database regarding feature information and content identification information corresponding thereto.

For example, the matching server may include a database including a fingerprint and content identification information corresponding thereto. The matching server may search feature information matched with the feature information received from the electronic device 100 in the database, and transmit content identification information corresponding to the searched feature information to the electronic device 100. The content identification information may include, for example, an intrinsic identification code for a content.

In the memory 110, information regarding a content such as the name, the genre, the cast, the producer, etc. of the content corresponding to the content identification information may be stored in advance, and the processor 120 may acquire information related to a viewing history on the basis of the pre-stored information as above and the content identification information received from the matching server. The pre-stored information may be, for example, Electronic Program Guide (EPG) metadata. Alternatively, the processor 120 may receive information on a content corresponding to the content identification information from an external server through a network such as the Internet. Or, it is also possible that the matching server provides information on a content corresponding to the feature information to the electronic device 100.

Meanwhile, in the embodiment described above, it was described that the electronic device 100 is provided with content identification information from the matching server, but it is also possible that the database of the aforementioned matching server is provided in the electronic device 100 and the electronic device 100 performs the function of the aforementioned matching server.

If it is determined that sufficient information related to a viewing history is acquired, the processor 120 may determine a keyword for a content search on the basis of the acquired information related to a viewing history. Here, the keyword may be associated with at least one of information expressing a content such as the title, the genre, the producer, the cast, etc. of the content.

Also, the processor 120 may determine a keyword for a content search on the basis of information related to content viewing histories of two or more content sources.

For example, the processor 120 may determine a keyword on the basis of at least one of first information related to a viewing history of a content corresponding to a broadcasting signal received through the tuner 130, second information related to a viewing history of a content provided from an external content providing device through the communicator 140, or third information related to a viewing history of a VOD content provided through an application stored in the memory 110.

In particular, the processor 120 may determine a keyword for a content search in consideration of all viewing histories of a linear content source and a non-linear content source.

According to an embodiment of the disclosure, the processor 120 may determine a keyword for each time zone from information related to a viewing history. For example, the processor 120 acquires information related to viewing histories of contents viewed through DIRECTV™ for the recent four weeks and information related to viewing histories of contents viewed through the YouTube™ application for the recent four weeks. Then, the processor 120 generates history rate information regarding which content genre was viewed the most for each time zone on the basis of the information related to the viewing histories of the contents viewed through DIRECTV™ for the recent four weeks. Then, the processor 120 generates history rate information regarding which content genre was viewed the most for each time zone on the basis of the information related to the viewing histories of the contents viewed through the YouTube™ application for the recent four weeks. Then, the processor 120 may generate history rate information regarding which content genre was viewed the most for each time zone when both of content viewing through DIRECTV™ and content viewing through the YouTube™ application were considered, on the basis of the history rate information of DIRECTV™ and the history rate information of the YouTube™ application. Then, the processor 120 may determine the genre that was viewed the most for each time zone as a keyword on the basis of the generated information. For example, if the sport genre was viewed the most between 10:00 a.m. and 11:00 a.m. when both of content viewing through DIRECTV™ and content viewing through the YouTube™ application were considered, ‘sport’ may be determined as the keyword corresponding to the time zone of between 10:00 a.m. and 11:00 a.m. In the aforementioned embodiment, it was described that the genre of a content is determined as a keyword, but this is merely an example, and any information regarding a content that can reflect a user's interest in the content such as the title, the cast, etc. of the content may be used as a keyword.

According to the embodiment as described above, a keyword may be acquired in consideration of not only viewing histories of linear contents (e.g., DIRECTV™) but also viewing histories of non-linear contents (e.g., YouTube™). Accordingly, a user's interest can be reflected more correctly without being deviated to a specific content source in an environment wherein various content sources are provided.

According to another embodiment of the disclosure, a keyword may be acquired on the basis of information related to a viewing history of a content of a specific content source, and a content of another content source may be recommended based on the keyword. For example, a content of a non-linear content source (e.g., YouTube™) may be recommended on the basis of information related to a viewing history of a content of a linear content source (e.g., DIRECTV™).

Hereinafter, a more specific example of acquiring a keyword for each time zone on the basis of information related to a viewing history will be described. In the example below, it will be described that a genre is used as a keyword, but another information that can express a viewed content other than a genre can obviously be used.

The processor 120 may acquire information related to a viewing history through image analysis as described above, or from an external manufacturer. The table 1 below describes an example of information related to a viewing history.

TABLE 1

| Starting Time | Finishing Time | Title of | Content |
|---|---|---|---|
| of Viewing | of Viewing | Viewed Content | ID |
| 2017-04-11 | 2017-04-11 | Sinking the Lusitania: | ba000000000003933376 |
| 02:24:39 | 02:27:23 | An American Tragedy | |
| 2017-04-11 | 2017-04-11 | Special Report With Bret | ba000000000022274637 |
| 22:00:12 | 22:15:20 | | |
| 2017-04-12 | 2017-04-12 | WWE Smack Down | ba000000000004208760 |
| 02:10:52 | 02:11:53 | | |
| 2017-04-12 | 2017-04-12 | Tucker Carlson Tonight | ba000000000032665850 |
| 02:12:52 | 02:16:44 | | |
| 2017-04-12 | 2017-04-12 | The World at War | ba000000000029546750 |
| 02:57:09 | 03:00:09 | | |
| 2017-04-12 | 2017-04-12 | Truth About Hunting | ba000000000014426497 |
| 03:30:13 | 03:51:50 | | |

The processor 120 may acquire a keyword for each time zone by using information related to a viewing history and electronic program guide (EPG) metadata. Specifically, the processor 120 may use a genre information table of EPG metadata. An example of a genre information table of EPG metadata is described in the table 2 below.

TABLE 2

| Country | Content ID | Genre |
|---|---|---|
| US | ba000000000022011437 | News |
| US | ba000000000022012417 | Other |
| US | ba000000000022012421 | Sport |
| US | ba000000000022098422 | Film |
| US | ba000000000022099884 | Other |
| US | ba000000000022101742 | News |

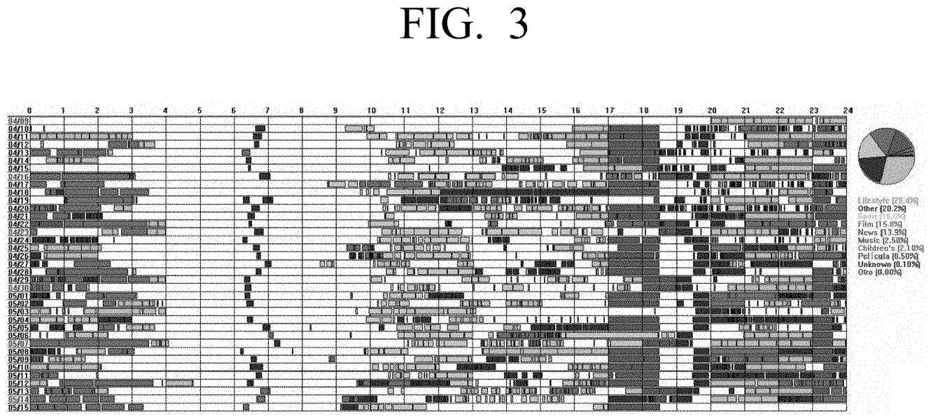

The processor 120 may acquire genre history information by matching a content ID of information related to a viewing history and a content ID of a genre information table of EPG metadata. An example of genre history information is described in FIG. 3.

FIG. 3 visualizes a viewing history of a user i accumulated for over five weeks. The horizontal axis indicates 24 hours (GMT), and the vertical axis indicates dates. Each genre is divided by indication in different colors. For effective processing of data, 24 hours (24*60=1440 minutes) is divided by units of 10 minutes and is divided into 144 units (j) in total. Whether the user i viewed a content at t minute may be divided as 0 and 1, and it will be indicated as t⁽ⁱ⁾.

Then, the accumulated viewing history fᵢ^{d}(j) in the j zone on the d date may be obtained as in the formula 1.

$${f}_{i}^{d} ( j ) = {\sum }_{m = 1 + ( i - 1 ) * 10}^{10 * j} {t}^{( i )} , where 1 \leq j \leq 144 \qquad formula 1$$

Also, the accumulated viewing history fᵢ^{D}(j) in the j zone on all dates D when data was collected is as in the formula 2 below.

$${f}_{i}^{D} ( j ) = {\sum }_{d ∈ D} {f}_{i}^{d} ( j ) , where D = \{ {d}_{1} , … , {d}_{N} \} \qquad formula 2$$

For obtaining the average viewing history, the average viewing history hᵢ^{D}(j) in the j zone during the D period may be obtained by using the formula 3 below.

$${h}_{i}^{D} ( j ) = \frac{1}{10 * \vert D \vert} * {f}_{i}^{D} ( j ) * 100 \qquad formula 3$$

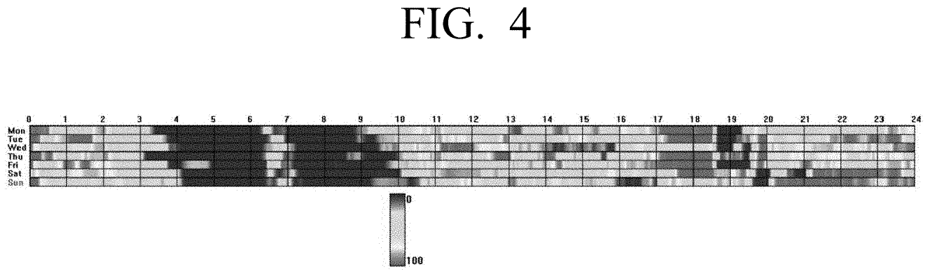

When the hᵢ^{D}(j) obtained as above is visualized, it is as in FIG. 4.

For calculating a preferred genre for each time zone, the accumulated viewing history of the k genre f_{i,k}^{d}(j) in the j zone on the d date of the user i may be obtained by the formula 4 below.

$${f}_{i , k}^{d} ( j ) = {\sum }_{m = 1 + ( j - 1 ) * 10}^{10 * j} {t}_{( k )}^{( i )} , where 1 \leq j \leq 144 \qquad formula 4$$

The accumulated viewing history f_{i,k}^{D}(j) on all dates D may also be obtained by the formula 5 below.

$${f}_{i , k}^{D} ( j ) = {\sum }_{d ∈ D} {f}_{i , k}^{d} ( j ) , where D = \{ {d}_{1} , … , {d}_{N} \} \qquad formula 5$$

By using the f_{i,k}^{D}(j) obtained as above and the fᵢ^{D}(j) obtained previously, the viewing history rate g_{i,k}^{D}(j) of the k genre on all dates D may be obtained as in the formula 6 below.

$${g}_{i , k}^{D} ( j ) = \frac{{f}_{i , k}^{D} ( j )}{{f}_{i}^{D} ( j )} \qquad formula 6$$

Among the viewing history rates g_{i,k}^{D}(j) for each genre in the j zone obtained as above, the biggest value G_{i,k}^{D}(j) may be obtained.

$${G}_{i , k}^{D} ( j ) = {max}_{1 \leq k \leq K} {g}_{i , k}^{D} ( j ) \qquad formula 7$$

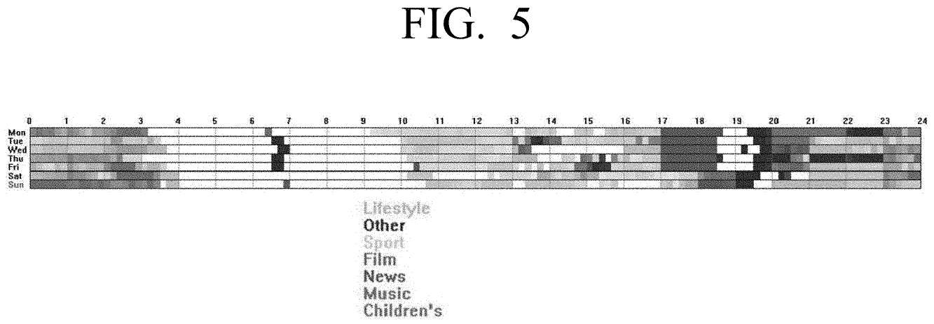

When the G_{i,k}^{D}(j) ultimately obtained as above is visualized, it is as in FIG. 5.

The preferred genre of a user for each time zone may be identified by distinction of indicating colors, and the preference rate of the genre may be identified by distinction of shades.

The processor 120 may determine the preferred genre of a user for each time zone as a keyword.

In case the electronic device 100 is implemented as a device that several users use together such as a TV or a set-top box, users may separately use the electronic device 100 in different time zones. Considering such a use pattern, a method of acquiring a keyword for each time zone is advantageous for recommending customized contents that are more personalized, as described above.

The processor 120 may search contents for each of a plurality of content sources based on a keyword corresponding to the current time zone.

According to an embodiment of the disclosure, if a predetermined event occurred, the processor 120 may search contents for each of a plurality of content sources based on a keyword corresponding to the time zone when the predetermined event occurred. For example, if the time when the predetermined event occurred is 10:30 a.m., the processor 120 may acquire a content search result for each of a plurality of content sources by using a keyword for a content search corresponding to the time zone of between 10:00 a.m. to 11:00 a.m.

Here, a predetermined event may be, for example, an event wherein a user selects a specific button of a remote control controlling the electronic device 100 and a control signal corresponding thereto is received at the electronic device 100. As another example, the electronic device 100 may receive a voice command, and the predetermined event may be an event wherein a user utters a specific voice, e.g., “Recommend me a content,” and the voice command is received at the electronic device 100. As another example, the predetermined event may be an event wherein the electronic device 100 is turned on. As another example, the predetermined event may be an event wherein a recommendation menu displayed on the display 150 is selected. As another example, the predetermined event may be an event wherein a predetermined time comes. However, the predetermined event is not limited to the aforementioned examples, and any case wherein content recommendation is required may be set as the predetermined event.

The processor 120 may search all of linear contents and non-linear contents based on a keyword for a content search, and provide the contents as recommended contents. That is, according to the disclosure, linear contents and non-linear contents may be recommended simultaneously. For example, the processor 120 may search a content corresponding to the keyword of the current time zone on the basis of EPG metadata and acquire a search result, and search a content corresponding to the keyword of the current time zone in an application providing VOD contents and acquire a search result, and provide recommended contents.

For example, in case a user uses the electronic device 100 at 11:00 a.m. on Thursday (GMT), it may be identified that the user mainly watches the sport genre in the time zone through information related to a viewing history in FIG. 5. If a detailed genre table of metadata is referred to, it is possible to identify a more detailed genre. If it is determined that the detailed genre is cycling, contents related to cycling may be recommended in, for example, the YouTube™ application which is a non-linear content source. Also, programs related to cycling among the contents that are currently being broadcast which are linear content sources may be recommended. This is recommendation of customized contents for a user who actually uses the electronic device 100 in the time zone. Also, it is possible to recommend the contents that are currently being broadcast together. Thus, such recommendation is an improved one in terms of accuracy and usefulness.

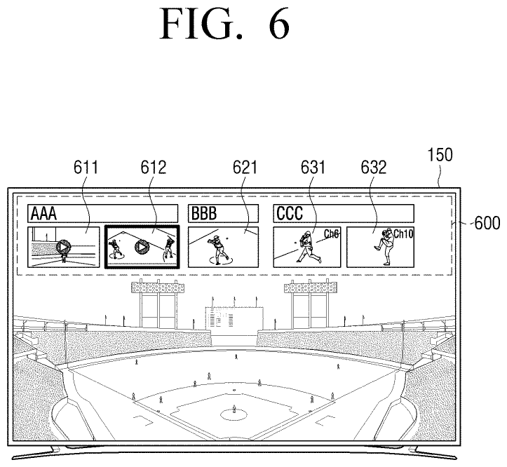

Based on a content search result for each of a plurality of content sources, the processor 120 may provide a content recommendation UI including recommended contents provided by each of the plurality of content sources through the display 150. An example of a content recommendation UI is described in FIG. 6.

Referring to FIG. 6, the display 150 may display a content recommendation UI 610. The content recommendation UI 610 provides recommended contents for each of an AAA content source, a BBB content source, and a CCC content source simultaneously on one screen. Specifically, the content recommendation UI 610 includes recommended contents 611, 612 provided by the AAA content source, the recommended content 621 provided by the BBB content source, and the recommended contents 631, 632 provided by the CCC content source. For example, the AAA content source may correspond to the YouTube™ application which is a non-linear content source, the BBB content source may correspond to the NETFLIX™ application which is a non-linear content source, and the CCC content source may correspond to the set-top box of DIRECTV™ which is a linear content source.

If a user command selecting any one recommended content provided in the content recommendation UI 610 is input through the inputter 160, the processor 120 may control the display 150 such that the selected recommended content is output.

For example, in case the electronic device 100 is controlled through an external remote control, a user may select a recommend content in the content recommendation UI 610 by manipulating direction keys, etc. provided on the remote control. A graphic element indicating selection may be displayed for the selected recommended content. For example, explaining with reference to FIG. 6, a graphic object enclosing the selected recommended content 612 may be displayed. If, for example, an identification button provided on the remote control is selected in such a state, the processor 120 may control the display 150 such that the selected recommended content 612 is output.

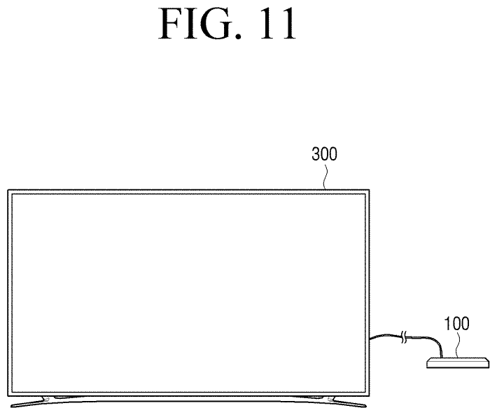

Meanwhile, in the aforementioned examples, it was described that a content recommendation UI is provided through the display 150 included in the electronic device 100, but according to another embodiment of the disclosure, the electronic device 100 may not include a display 150. In this case, as illustrated in FIG. 11 for example, the electronic device 100 may be connected with an external display device 300 and output a video signal and/or an audio signal to the display device 300. In FIG. 11, a case wherein the display device 300 is a TV is illustrated, but the display device 300 is not limited thereto, and any device having a display function can be the display device 300.

The processor 120 may output an image signal corresponding to the content recommendation UI to the display device 300 such that the content recommendation UI is displayed on the display device 300.

As an example, the electronic device 100 may be a set-top box, and the display device 300 may be a TV, a PC, a laptop computer, etc. connected with the set-top box. As another example, the electronic device 100 may be a server, and the display device 300 may be a device such as a TV, a smartphone, a PC, etc. communicatively connected with the server. In FIG. 11, it is illustrated that the electronic device 100 and the display device 300 are connected via wire, but wireless connection is also possible. According to an embodiment of the disclosure, a content source that will recommend contents may be determined on the basis of use history information for each of a plurality of content sources.

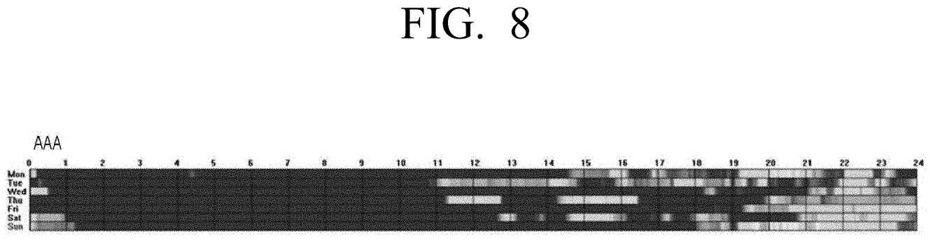

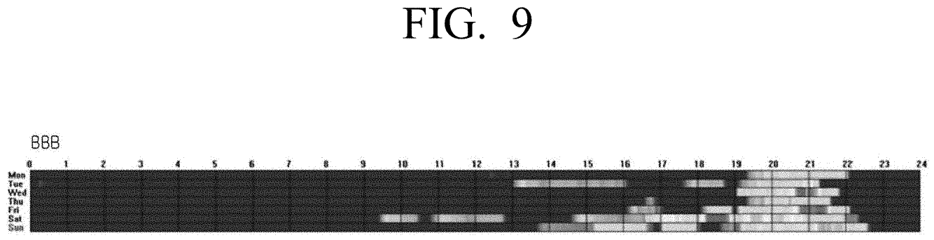

According to this embodiment, the processor 120 may acquire information on a use history of each of the plurality of content sources and store the information in the memory 110. For example, the processor 120 may acquire information on the use time of an external content providing device connected with the electronic device 100, and information on the use time of an application for providing VOD contents installed on the electronic device 100. Then, the processor 120 may generate use history information indicating which content source was used a lot for each time zone on the basis of information acquired as above. For example, the processor 120 may calculate the use history for each time zone of each content source by the same method as the method of calculating the average viewing history by using the aforementioned formula 3. In FIGS. 8 and 9, examples of use histories for each time zone of a content source are visualized and illustrated. FIG. 8 describes use histories for each time zone of the AAA content source, and FIG. 9 describes use histories for each time zone of the BBB content source. For example, the AAA content source may correspond to the YouTube™ application, and the BBB content source may correspond to the NETFLIX™ application.

According to an embodiment of the disclosure, the processor 120 may determine content sources in an n number that were used the most in the current time zone when content recommendation is performed as sources to recommend contents, on the basis of use histories for each of the plurality of content sources. Here, n is a number greater than or equal to 1, and may be set appropriately according to implementation forms. For example, to a user of the electronic device 100 during the morning time, contents through the YouTube™ application and contents through the NETFLIX™ application may be recommended, and to a user of the electronic device 100 during the afternoon time, contents through DIRECTV™ and contents through the YouTube™ application may be recommended.

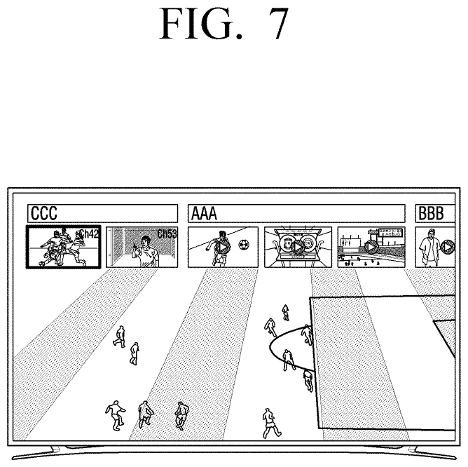

Also, according to an embodiment of the disclosure, the processor 120 may determine the arrangement order of recommended contents on the basis of use histories for each of the plurality of content sources. Explaining with reference to FIG. 6, in case the content source used the most in the current time zone when content recommendation is performed is the AAA content source, and the content source used the next most is the BBB content source, and the content source used the next most is the CCC content source, recommended contents may be listed in the order of the AAA content source, the BBB content source, and the CCC content source, as illustrated in FIG. 6. Such an arrangement order may be changed when the use histories of the content sources are updated. For example, as illustrated in FIG. 7, the arrangement order of recommended contents may be determined as an order of the CCC content source, the AAA content source, and the BBB content source.

In addition, according to an embodiment of the disclosure, the processor 120 may determine the number of recommended contents of each of the plurality of content sources to be provided in the content recommendation UI, on the basis of use history information for each of the plurality of content sources. Explaining with reference to FIG. 7, in case the AAA content source was used more than the CCC content source, the number of recommended contents (three) of the AAA content may be set to be greater than the number of recommended contents (two) of the CCC content.

Further, according to an embodiment of the disclosure, in case recommended contents greater than the display area of the display 150 are recommended, the processor 120 may perform a recommendation content scroll function. Explaining with reference to FIG. 7, if a user command for scrolling recommended contents to the right is input through the inputter 160, recommended contents of the BBB content source existing on the outer right side of the screen may be displayed.

Meanwhile, in the aforementioned embodiment, it was described that contents for a plurality of content sources are searched and recommended, but the number of content sources is not necessarily limited to a plural number, and it is possible that contents for one content source are searched and recommended.

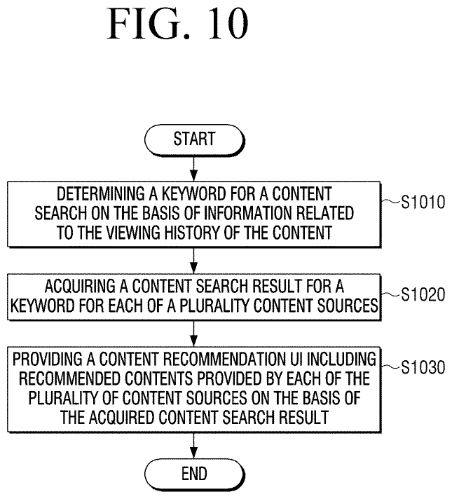

FIG. 10 is a flow chart for illustrating a control method of an electronic device according to an embodiment of the disclosure. The flow chart illustrated in FIG. 10 may consist of operations processed at the electronic device 100, which are described in this specification. Accordingly, the contents described regarding the electronic device 100 may also be applied to the flow chart illustrated in FIG. 10, even if they are omitted below.

Referring to FIG. 10, the electronic device determines a keyword for a content search on the basis of information related to a viewing history of a content at operation S1010.

Information related to a viewing history of a content may be at least one of information related to a viewing history of a content corresponding to a broadcasting signal received through the tuner of the electronic device, information related to a viewing history of a content provided from an external content providing device connected with the electronic device, or information related to a viewing history of a video on demand (VOD) content provided through an application stored in the electronic device.

A keyword for a content search may be determined on the basis of at least one among information related to various viewing histories as above.

In this case, the electronic device may determine a keyword for a content search for each time zone on the basis of information related to viewing histories. For example, the electronic device may determine a keyword corresponding to the time zone of from 9:00 a.m. to 10:00 a.m., a keyword corresponding to the time zone of from 10:00 a.m. to 11:00 a.m., etc.

Meanwhile, a keyword may be determined on the basis of another information that can reflect a user's interest other than a viewing history. For example, a search word that a user input into the electronic device 100 for a web search, a VOD search, etc. may be determined as a keyword.

Then, the electronic device acquires a content search result for the determined keyword for each of the plurality of content sources at operation S1020.

A keyword reflects a user's interest based on a viewing history of the user, and thus contents which the user is expected to be interested in may be searched based on such a keyword.

Then, the electronic device provides a content recommendation UI including recommended contents provided by each of the plurality of content sources based on the acquired content search result at operation S1030.

The content recommendation UI may provide recommended contents of each of the plurality of content sources simultaneously. Accordingly, a user can be provided with recommended contents of various content sources.

The arrangement order of recommended contents provided in the content recommendation UI may be determined on the basis of use history information for each of the plurality of content sources. According to another embodiment of the disclosure, the number of recommended contents of each of the plurality of content sources to be provided in the content recommendation UI may be determined on the basis of use history information for each of the plurality of content sources. According to this embodiment, contents which a user is interested in can be recommended, and also, contents of a content source that a user used a lot can be recommend preferentially, and in a large amount.

According to the aforementioned embodiments of the disclosure, contents may be recommended while reflecting a user's preference for each time zone, and thus recommendation of contents that can satisfy a user's interest more correctly compared to the conventional method of recommending contents based on the total viewing time is possible. Also, according to the aforementioned embodiments of the disclosure, contents can be recommended based on histories of various content sources. In addition, according to the aforementioned embodiments of the disclosure, it is possible to recommend contents of another content source based on a viewing history of a specific content source. Accordingly, for example, even if a TV does not have a content viewing history through an OTT application (non-linear contents, e.g., the YouTube™ contents) by itself, if the TV has a viewing history of broadcasting contents (linear contents), it is possible to recommend contents of an OTT application based on this. Further, according to the aforementioned embodiments of the disclosure, contents of various content sources can be recommended simultaneously on one screen, and thus recommended contents can be provided to a user in an integrated way. By virtue of this, a user can access recommended contents of various content sources through minimum remote control manipulations. Also, it is possible to adjust the order of recommendation or the rate of recommendation based on use histories of content sources.

Meanwhile, the aforementioned various embodiments may be implemented in a recording medium that can be read by a computer or a device similar to a computer, by using software, hardware, or a combination thereof. According to implementation by hardware, the embodiments described in the disclosure may be implemented by using at least one of Application Specific Integrated Circuits (ASICs), digital signal processors (DSPs), digital signal processing devices (DSPDs), programmable logic devices (PLDs), field programmable gate arrays (FPGAs), processors, controllers, micro-controllers, microprocessors, or an electronic unit for performing various functions. According to implementation by software, the embodiments such as procedures and functions described in this specification may be implemented as separate software modules. Each of the software modules may perform one or more functions and operations described in this specification.

Computer instructions for performing the processing operations at the electronic device 100 according to the aforementioned various embodiments of the disclosure may be stored in a non-transitory computer-readable medium. Such computer instructions stored in a non-transitory computer-readable medium make the processing operations at the electronic device 100 according to the aforementioned various embodiments performed by a specific device, when the instructions are executed by the processor of the specific device.

For example, a non-transitory computer-readable medium storing a computer instruction that makes a specific device perform an operation including the steps of determining a keyword for a content search on the basis of viewing history information for a content, acquiring a content search result for the keyword for each of a plurality of content sources, and providing, on the basis of the acquired content search result, a content recommendation UI including the recommended contents provided by each of the plurality of content sources, when the instruction is executed by the processor of the specific device, may be provided.

A non-transitory computer-readable medium refers to a medium that stores data semi-permanently, and is readable by machines, but not a medium that stores data for a short moment such as a register, a cache, and a memory. As specific examples of a non-transitory computer-readable medium, there may be a CD, a DVD, a hard disk, a blue-ray disk, a USB, a memory card, a ROM and the like.

According to an embodiment of the disclosure, the method according to the various embodiments described in the disclosure may be provided while being included in a computer program product. A computer program product refers to a product, and it can be traded between a seller and a buyer. A computer program product can be distributed on-line in the form of a storage medium that is readable by machines (e.g.: a compact disc read only memory (CD-ROM)), or through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

While preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Also, it is intended that such modifications are not to be interpreted independently from the technical idea or prospect of the disclosure.

What is claimed is:

1. An electronic device comprising:
a memory configured to store information related to a viewing history of a content; and
a processor configured to:
determine a keyword for a content search on the basis of information related to the viewing history, acquire a content search result for the keyword for each of a plurality of content sources, and provide, on the basis of the acquired content search result, a content recommendation UI including the recommended contents provided by each of the plurality of content sources.

2. The electronic device of claim 1, further comprising:
a tuner configured to receive a broadcasting signal; and
a communicator configured to connect with an external content providing device,
wherein the processor is configured to:
acquire at least one of first information related to a viewing history of a content corresponding to a broadcasting signal received through the tuner, second information related to a viewing history of a content provided from the external content providing device through the communicator, or third information related to a viewing history of a video on demand (VOD) content provided through an application stored in the memory, and store the information in the memory.

3. The electronic device of claim 2,
wherein the processor is configured to:
determine a keyword for a content search based on at least one of the first information, the second information, or the third information.

4. The electronic device of claim 1,
wherein the processor is configured to:
determine a keyword for a content search for each time zone on the basis of the information related to the viewing history.

5. The electronic device of claim 1,
wherein the keyword is associated with at least one of the title, the genre, the producer, or the cast of a viewed content.

6. The electronic device of claim 1,
wherein the content recommendation UI provides recommended contents of each of the plurality of content sources simultaneously.

7. The electronic device of claim 1,
wherein the memory stores use history information for each of the plurality of content sources, and
the processor is configured to:
determine the arrangement order of recommended contents provided in the content recommendation UI on the basis of the use history information.

8. The electronic device of claim 1,
wherein the memory stores use history information for each of the plurality of content sources, and
the processor is configured to:
determine the number of recommended contents of each of the plurality of content sources to be provided in the content recommendation UI on the basis of the use history information.

9. The electronic device of claim 1,
wherein the processor is configured to:
analyze an image of a viewed content and acquire the information related to the viewing history.

10. The electronic device of claim 1,
wherein the plurality of content sources include a real time broadcasting program providing source and a VOD content providing source.

11. The electronic device of claim 1,
wherein the processor is configured to:
output an image signal corresponding to the content recommendation UI to an external display device and provide the content recommendation UI through the external display device.

12. A method for controlling an electronic device, the method comprising:
determining a keyword for a content search on the basis of information related to a viewing history of a content;
acquiring a content search result for the keyword for each of a plurality of content sources; and
providing, on the basis of the acquired content search result, a content recommendation UI including the recommended contents provided by each of the plurality of content sources.

13. The control method of claim 12, further comprising:
acquiring at least one of first information related to a viewing history of a content corresponding to a broadcasting signal received through the tuner of the electronic device, second information related to a viewing history of a content provided from an external content providing device connected with the electronic device, or third information related to a viewing history of a video on demand (VOD) content provided through an application stored in the electronic device.

14. The control method of claim 13,
wherein the determining a keyword comprises:
determining a keyword for a content search based on at least one of the first information, the second information, or the third information.

15. The control method of claim 12,
wherein the determining a keyword comprises:
determining a keyword for a content search for each time zone on the basis of the information related to the viewing history.
